(19) United States
(12) Patent Application Publication
(10) Pub. No.: US 2009/0138319 A1
(43) Pub. Date: May 28, 2009

(54) TASK REGISTRATION METHODS AND SYSTEMS

(76) Inventor: Kiran Kumar Satya Srinivasa Ratnala, Bangalore (IN)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 12/275,232

(22) Filed: Nov. 21, 2008

(30) Foreign Application Priority Data
Nov. 22, 2007 (IN) 2737/CHE/2007

(51) Int. Cl. G06Q 10/00

(52) U.S. Cl. 705/9

(57) ABSTRACT

Embodiments of the invention comprise a method of registering a task in respect of a user, the method comprising determining if the user would conform to at least one of delegation and separation of duty (SoD) policies if the user carried out the task; and selectively registering the task in respect of the user based on the determining.

### RELATED APPLICATIONS

Benefit is claimed under 35 U.S.C. 119(a)-(d) to Foreign application Ser No. 2737/CHE/2007 entitled “TASK REGISTRATION METHODS AND SYSTEMS” by Hewlett-Packard Development Company, L.P., filed on 22 Nov. 2007, which is herein incorporated in its entirety by reference for all purposes.

### BACKGROUND OF THE INVENTION

An enterprise (for example, a company or some other organization) often has a large IT system (information technology system) that users may use to carry out tasks. An IT system may comprise, for example, data processing systems, storage, networking components linking parts of the IT system together and the like.

A user may wish to delegate a task or parts of a task to another user. The delegation is typically performed by a security officer who grants the user having the task delegated to him sufficient permissions, privileges and/or authorizations to carry out the delegated task. Such delegation may make use of users who are particularly suitable for carrying out certain tasks. Delegation may also allow delegating users to carry out other tasks. An enterprise may have policies in place that impose restrictions on delegation and how tasks (or parts of a task) can be distributed among users.

A user may attempt to carry out a task for which the user is not authorized or not suitable. An enterprise may wish to reduce or eliminate the consequences of such actions by requiring users to register tasks before the users can perform the task. For example, a user must register a task before that user can carry out that task.

It is an object of embodiments of the invention to at least mitigate one or more of the problems of the prior art.

### BRIEF DESCRIPTION OF THE DRAWINGS

Embodiments of the invention will now be described by way of example only, with reference to the accompanying drawings, in which:

FIG. 1 shows an example of a system for registering a task according to embodiments of the invention;

FIG. 2 shows an example of a method of registering a task according to embodiments of the invention; and

FIG. 3 shows an example of a data processing system suitable for use with embodiments of the invention.

### DETAILED DESCRIPTION OF EMBODIMENTS OF THE INVENTION

In large enterprises and/or large IT systems, delegation of tasks to users may require a significant amount of effort from security officers. Embodiments of the invention may reduce the effort required by security officers by allowing users to delegate tasks based on a delegation policy and/or separation of duty (SoD) policy, and to incorporate such policy checks into the task registration process such that a user can only register to perform a task if the user is authorized to carry out the task or owns the task, or if the user has had the task delegated to him by a user who owns or is authorized to carry out the task. In this way, intervention is not required when a task is delegated to a user. Furthermore, when a user attempts to carry out a task, a check to determine whether the user has registered the task also incorporates a check of the delegation and/or SoD policies as the task will not be registrable by that user if this would violate the delegation and/or SoD policies. Thus, a check of the delegation and/or SoD policies themselves may not be required at run-time.

In certain IT systems that also include run-time delegation and/or SoD policy validation checks, the result of policy checks performed during task registration may be stored in a policy validation cache such that when run-time policy validation checks are performed, the policy validation cache may be checked instead of databases describing the policies. Checking the cache may be a more efficient (for example, faster) operation than checking the databases themselves for conformity. The run-time policy validation checks may comprise, for example, checks of the delegation, RBAC and/or SoD policies, and may include consultation of the relevant databases.

Tasks that may be carried out on an IT system may include, for example, mounting a file system, configure a printer within the IT system, upgrading software on a data processing system or configuring an email account associated with a user.

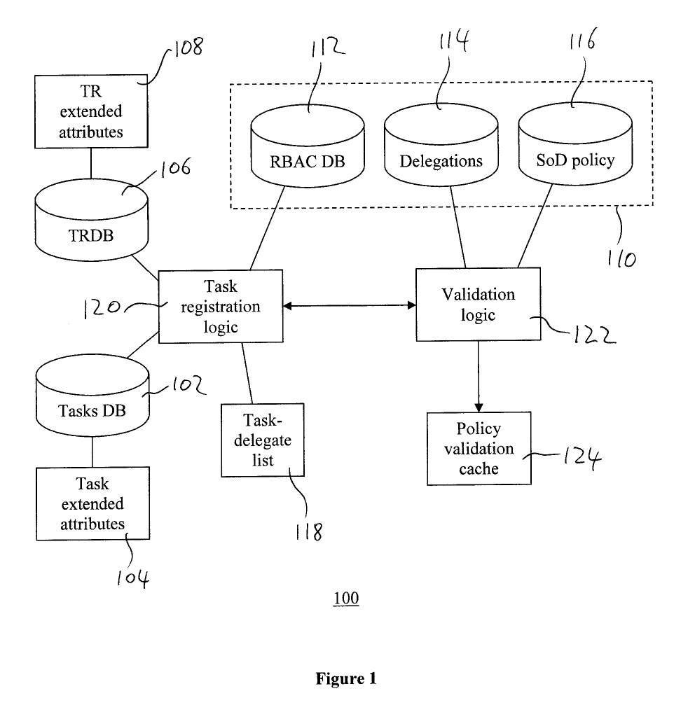

FIG. 1 shows a system 100 for registering a task according to embodiments of the invention. The system 100 includes a tasks database (DB) 102. The tasks database 102 contains a list of the tasks that are available to do on the IT system. For example, tasks may include upgrading certain software on a data processing system, configuring an email client on a data processing system and the like. The tasks DB 102 also contains (or is associated with) task extended attributes 104. The task extended attributes 104 define extended attributes for each task listed in the tasks DB 102. The extended attributes 104 comprise:
delegate—indicates whether the task can be delegated or not, or whether the ability to delegate the task should be checked according to a separate delegation policy.
active—this attribute can be used to mark the task as active or not.
separation of duty (SoD)—indicates whether SoD of the task should be checked according to a separate SoD policy.
task importance—indicates whether the importance of the task is (for example) high, medium or low.
task priority—indicates whether or not the task is a priority task.

A system administrator may create and/or maintain the Tasks database 102 and/or the task extended attributes 104.

The system 100 of FIG. 1 also includes a task registration database (TRDB) 106. A task must be registered by a user before that user can carry out the task, and the TRDB 106 contains a list of registered tasks and the users that registered the tasks. Thus, if a user attempts to carry out a task that is not indicated in the TRDB 106 as being registered by that user, the user will not be able to carry out the task. This check is done at run-time when the user attempts to carry out the task.

The TRDB may contain (or be associated with) task registration (TR) extended attributes 108. The TR extended attributes define extended attributes of users that have registered tasks. The TR extended attributes 108 contain the following attributes for each registered user:
quality of service (QoS)—indicates the quality of service provided by the user carrying out the task. This attribute is updated once the task has been completed, for example by the user who carried out the task, that person's supervisor or a system administrator. This attribute may comprise, for example, a numerical value from 1-5, where 5 is the highest QoS.
trust—indicates the trust level of the user, for example high, medium or low. This attribute can be used, for example, to ensure that a sensitive or important task is not delegated to users with a trust level that is too low.
delegate—indicates whether the user registered to perform the task is a delegate of the task, in that the task has been delegated to the registered user.
user load—this attribute shows the user's load level. For example, a user's load level may increase as more tasks are delegated or assigned to him. If the user's load level becomes too high (for example, over a threshold value), the task registration system 100 may prevent further tasks from being delegated to the user.

A user may be registered against multiple tasks. Therefore, the user may have multiple entries in the TR extended attributes 108 corresponding to respective registered tasks. Also, a task may be registered by multiple users.

The system 100 may include an access control policy 110. The access control policy 110 is, for example, an enterprise's policy for access control, delegation and the like within the enterprise's IT system. The access control policy 110 may include a role-based access control database (RBAC DB) 112. The RBAC DB 112 indicates roles associated with users. For example, a user may have one or more roles, and/or one or more users may have a particular role. A role may be associated with operations that can or cannot be carried out by a user with that role. For example, a user with a certain role may be able to carry out certain tasks and/or may not be able to carry out certain tasks.

The access control policy 110 may include a delegations database (DB) 114. The delegations DB 114 may indicate an enterprise's delegation policy. For example, the delegation policy may indicate the tasks which may or may not be delegated, the users that are able to delegate tasks to other users and/or the users to which tasks may be delegated.

The access control policy 110 may also include a separation of duty (SoD) policy database 116. The SoD policy DB 116 indicates the enterprise's SoD policy. The SoD policy ensures that certain operations are split up between users such that, for example, one or more users are not granted access to all of a certain collection of tasks at one time. For example, the SoD policy may indicate that no user may possess at one time the ability to carry out task 1, task 2 and task 3. The user may, for example, be able to carry out tasks 1 and 2, and then relinquish the ability to carry out task 1 and/or 2 in order to obtain the ability to carry out task 3.

The system 100 may include a task delegate list 118. The task-delegate list 118 contains a list of delegated tasks and the users to which those tasks have been delegated. Tasks can be delegated, for example, by users authorized to delegate or carry out the tasks, and/or owners of the tasks. An example of a task-delegate list is given below:

| Task | Delegate |
|---|---|
| MountFileSystem | Lee, John |
| ConfigPrinter | Lee |

The above example of a task-delegate list 118 indicates that the “MountFileSystem” task has been delegated to users “Lee” and “John”, and the “ConfigPrinter” task has been delegated to “Lee”. The task-delegate list may be updated, for example, by a user delegating a task to another user. The user delegating the task may, for example, use an application or command-line utility to update the task-delegate list 118. The task-delegate list 118 may also be updateable to remove delegations of tasks to users. The task-delegate list 118 may be used at run-time, for example, to check whether the task has been delegated to the user and that the user can carry out the task. However, embodiments of the invention may omit this step and the task-delegate list 118 if it is deemed that registration of a task by a user or not is sufficient enforcement of enterprise policies (such as the delegation policy).

The system 100 may comprise, for example, one or more data processing systems that are within or accessible by an enterprise's IT system. Software executing on the data processing system or systems may include the HP-UX operating system.

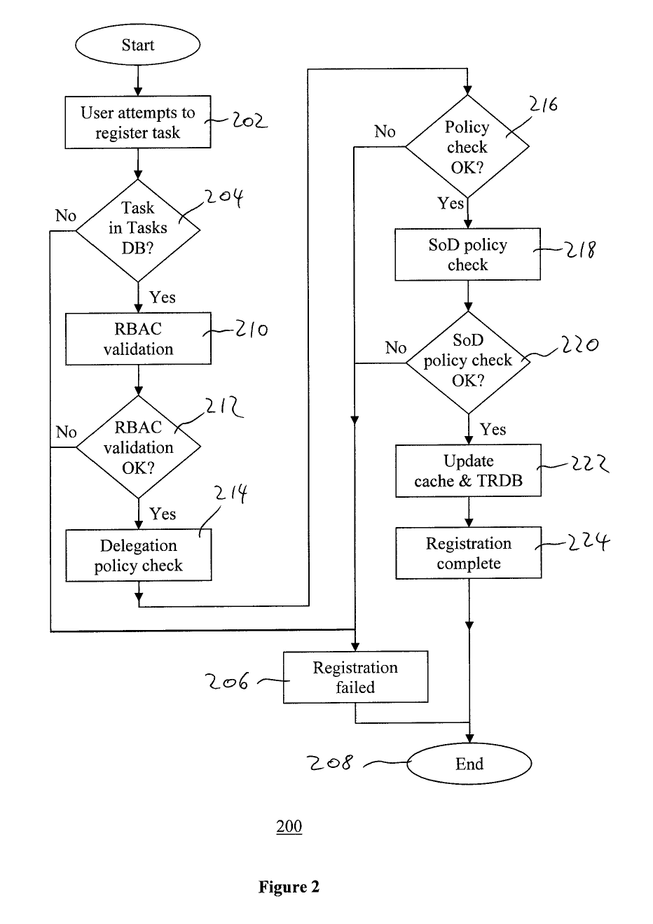

FIG. 2 shows an example of a method 200 for registering a task according to embodiments of the invention. The delegation and SoD policies are checked during task registration and so these policies do not have to be re-checked at run-time.

The method 200 starts at step 202 where a user attempts to register a task. This is done by the user sending a task registration request to task registration logic 120 (shown in FIG. 1). The user may send such a request, for example, by using a task registration utility and/or executing a task registration command on a data processing system.

The method 200 then proceeds to step 204, where it is determined whether the task exists in the tasks database 102. This is done by the task registration logic accessing the tasks database to check for the existence of the task to be registered. Also, in step 204, it is determined whether attributes of the user registering the task meet certain minimum requirements. These minimum requirements can be determined in a number of ways. For example, the QoS and/or Trust attributes of a user registering the task may be required to meet certain minimum levels based on the task importance attribute (found in the task extended attributes 104). User attributes may be found, for example, in a user profile (not shown) associated with the user and located within or accessible by the enterprise's IT system. This user profile may also indicate (directly or indirectly) whether the user is authorized to delegate tasks to others.

In embodiments of the invention, where an enterprise's IT system includes a “Q1 database” (not shown in the figures; also known as a Task-QoS-User database), the QoS attribute of a user may be extracted from the Q1 database. Below is an example of entries in an example Q1 database:

| Task | Qos | User |
|---|---|---|
| ConfigPrinter | 3 | Lee |
| ConfigEmail | 7 | Lee |
| MountFileSystem | 2 | John |

In the above example, the Q1 database shows that the user “Lee” carries out the “ConfigPrinter” task to configure a printer with a quality of service (QoS) level of 2. Similarly, the user “Lee” carries out the “ConfigEmail” task with a QoS level of 7, and the user “John” carries out the “MountFileSystem” task with a QoS level of 2. The QoS level is, in this example, an integer value from 1 to 10, where 1 is a low QoS and 10 is a high QoS. In other embodiments, the QoS level may be specified in other ways, such as, for example, three levels “high”, “medium” and “low”. Embodiments of the invention may extract the QoS level of the user for the task which the user is trying to register, and use the QoS level to determine whether the user meets certain QoS criteria (for example, to determine whether the user has a certain minimum QoS level based on the task importance attribute of the task). The Q1 database may be updated (for example, by a user, system administrator or user's supervisor) to adjust the QoS attribute once a task is completed by the user.

Also, in step 204, the task-delegate list 118 may be checked by the task registration logic 120. For example, if the user would not normally be allowed to registering the task he is trying to register, the task-delegate list 118 explicitly indicates that the user has had the task delegated to him by an authorized user and therefore the user trying to register the task should be allowed to register and carry out the task.

If in step 204 it is determined that the task does not exist, or that the user does not conform to minimum requirements, then the method 200 proceeds to step 206, where task registration has failed. The user may be informed of the failure of the task registration (for example, through an error message). The method 200 then ends at step 208.

If, in step 204, it is determined that the task exists within the tasks DB 102, then the method 200 proceeds to step 210 where RBAC validation is performed. The task registration logic 120 checks the RBAC database 112 to determine whether the user attempting to register the task has an appropriate role that allows the user to carry out the task. The method 200 then proceeds to step 212, where it is determined whether the RBAC validation was successful. If not, then the registration has failed at step 206 and the method ends at step 208. Thus, role-based access control (RBAC) is implemented in the system 100 shown in FIG. 1.

If, on the other hand, RBAC validation was successful, then the method 200 proceeds from step 212 to step 214 where a delegation policy check is carried out. This is done, for example, by the task registration logic shown in FIG. 1 sending a delegation and SoD validation request to validation logic 122. The validation logic 122 checks the delegations database 114 to determine whether the task can be delegated to the user attempting to register the task. For example, the validation logic 122 determines whether that task is delegatable, whether the user can have that task delegated to him and/or whether a user who is responsible for the task is authorized to delegate tasks to others. Next, in step 216, it is determined whether the delegation policy check in step 214 indicated that registration of the task by the user conforms to the delegation policy indicated in the delegations database 114. If this is not the case, and the user registering the task would violate the delegation policy, then the method continues to step 206 where task registration fails, and then to step 208 where the method ends.

In embodiments of the invention, where task extended attributes 104 include a delegate attribute, steps 214 and 216 may be skipped if the delegate attribute of a task indicates that the delegation policy need not be checked when registering the task. Alternatively, where the delegate attribute indicates that the delegation policy should be checked, steps 214 and 216 are carried out.

If registration of the task does not violate the delegation policy (or if steps 214 and 216 are skipped) then the method 200 proceeds to step 218 where a SoD policy check is performed to check whether registration of the task by the user conforms to a SoD policy indicated in the SoD policy database 116. The method 200 then proceeds to step 220 where the result of the determination in step 218 is checked. If the SoD policy would be violated then the task registration fails at step 206 and the method ends at step 208.

In embodiments of the invention, where task extended attributes 104 include a SoD attribute, steps 218 and 220 may be skipped if the SoD attribute of a task indicates that the SoD policy need not be checked when registering the task. Alternatively, where the SoD attribute indicates that the SoD policy should be checked, steps 218 and 220 are carried out.

If the policy would not be violated (or if steps 218 and 220 are skipped) then the method 200 instead proceeds to step 222 where a policy validation cache 124 (shown in FIG. 1) and task registration database (TRDB) 106 are updated. The policy validation cache 124 is updated to reflect the fact that the user registering and/or carrying out the tasks conforms to the delegations policy and the SoD policy, and does not violate these policies. Updating of the TRDB 106 (and associated TR extended attributes 108) may be done, or example, by the validation logic 122 returning information to the task registration logic 120 indicating that the delegation policy and SoD policy checks were successful. The task registration logic 120 then updates the TRDB 106. The method 200 then proceeds to step 224, where task registration is complete. The user may be informed of the completion of the task registration (for example, through a message). The method 200 then ends at step 208.

Thus, in the method described above, the task is not registered by the user attempting to register the task if registration of the task by the user (and subsequent carrying out of the task by the user) would violate the delegation and/or separation of duty (SoD) policies. Therefore, checks against the policies are integrated into the task registration process such that a check of the TRDB at run-time for task registration by a user attempting to carry out the task may be sufficient to determine whether the policies are conformed to or violated.

When a user attempts to carry out a task, for example by attempting to execute commands associated with the task, a check is made at run-time of the TRDB 106. If the TRDB 106 shows that the user is registered to perform the task, then the task is carried out as appropriate (for example, the commands are executed). If the TRDB 106 does not indicate that the user is registered to perform the task, the user will not be able to carry out a task (for example, the commands are not executed) and the user may be presented with an error message, for example.

In embodiments of the invention where additional delegation and SoD policy validation checks are performed at run-time when the user attempts to carry out the task, the policy validation cache 124 may be consulted instead of the delegations policy database 114 and SoD policy 116 database to determine whether the user carrying out the task violates these policies. This may be a more efficient (for example, faster) way of determining policy conformity compared to consultation of the databases 114 and 116.

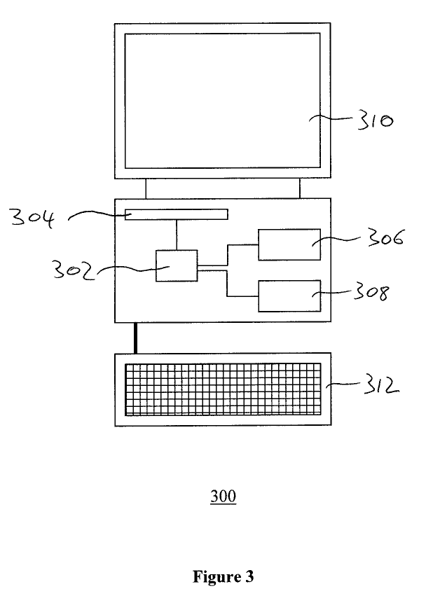

FIG. 3 shows an example of a data processing system 300 that is suitable for use with embodiments of the invention. The data processing system 300 includes one or more data processors 302 and main memory 304. The data processing system may also include a permanent storage device 306 (such as a hard disk) and/or a communications device 308 that enables the data processing system 300 to communicate with other data processing systems and/or parts of an enterprise's IT system. The data processing system may also include a display device 310 and/or a human interface device 312 (such as a mouse and/or keyboard).

Embodiments of the invention implement a system 100 according to embodiments of the invention that includes the HP-UX operating system and/or RBAC (role-based access control). Such a system includes authorizations and roles. An authorization allows a user with that authorization to register and carry out a task associated with the authorization, and may also allow the user to delegate the task to others. Roles are associated with one or more authorizations, and users may be assigned one or more roles. So, for example, a user with a certain role may, through the role, be granted authorizations to carry out certain tasks.

Embodiments of the invention define extended attributes associated with roles and authorizations. The extended attributes may be stored, for example, within the RBAC database 112 (shown in FIG. 1) or elsewhere. The extended attributes include the following attributes for each role:
delegate—indicates whether or not the role can be delegated.
SoD—indicates whether the separation of duty (SoD) policy should be checked when a registered user is attempting to register a task for which the role gives authorization to carry out.

The extended attributes also define the following attributes for each authorization:
delegate—indicates whether or not the authorization can be delegated.
SoD—indicates whether the separation of duty (SoD) policy should be checked when a registered user is attempting to register a task which the authorization allows the user to carry out.

The following table indicates an example of a delegation policy matrix indicating which roles can and cannot be delegated:

| | |
|---|---|
| Roles | Authorizations |

| | | D | ND | D | ND |
|---|---|---|---|---|---|
| Roles | D | Y | Y | Y | N |
| | ND | N | N | N | N |
| Authorizations | D | Y | N | NV | NV |
| | ND | N | N | NV | NV |

In the above table, D is delegatable, ND is non-delegatable, Y means one can be delegated to the other, N means one cannot be delegated to the other, and NV means not valid operation. The table indicates which authorizations (and thus the tasks associated with the authorizations) and roles can be delegated to which roles. For example, a delegatable role or a delegatable authorization can be delegated to a delegatable role. A non-delegatable role or authorization cannot be delegated. A delegatable authorization can be delegated to a delegatable role but not to a non-delegatable role, and this prevents, for example, delegatable authorizations from being “locked” into non-delegatable roles and thus being prevented from being delegated further by users with those roles.

It will be appreciated that embodiments of the present invention can be realised in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are embodiments of machine-readable storage that are suitable for storing a program or programs that, when executed, implement embodiments of the present invention. Accordingly, embodiments provide a program comprising code for implementing a system or method as claimed in any preceding claim and a machine readable storage storing such a program. Still further, embodiments of the present invention may be conveyed electronically via any medium such as a communication signal carried over a wired or wireless connection and embodiments suitably encompass the same.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. The claims should not be construed to cover merely the foregoing embodiments, but also any embodiments which fall within the scope of the claims.

1. A method of registering a task in respect of a user, the method comprising:
determining if the user would conform to at least one of delegation and separation of duty (SoD) policies if the user carried out the task; and
selectively registering the task in respect of the user based on the determining.

2. A method as claimed in claim 1, comprising storing the result of the determining in a policy validation cache.

3. A method as claimed in claim 1, comprising registering the task if the user would conform to the at least one of delegation and separation of duty (SoD) policies if the user carried out the task.

4. A method as claimed in claim 1, comprising checking whether the user conforms to attributes associated with the task, and registering the task only if the user conforms to the attributes.

5. A system for registering a task in respect of a user, the system being arranged to:
determine if the user would conform to at least one of delegation and separation of duty (SoD) policies if the user carried out the task; and
selectively register the task in respect of the user based on the determining.

6. A system as claimed in claim 5, arranged to store the result of the determining in a policy validation cache.

7. A system as claimed in claim 5, arranged to register the task if the user would conform to the at least one of delegation and separation of duty (SoD) policies if the user carried out the task.

8. A system as claimed in claim 5, arranged to check whether the user conforms to attributes associated with the task, and registering the task only if the user conforms to the attributes.

9. A computer program for registering a task in respect of a user, the computer program comprising computer readable instructions for:
determining if the user would conform to at least one of delegation and separation of duty (SoD) policies if the user carried out the task; and
selectively registering the task in respect of the user based on the determining.

10. A computer program as claimed in claim 9, comprising computer readable instructions for storing the result of the determining in a policy validation cache.

11. A computer program as claimed in claim 9, comprising computer readable instructions for registering the task if the user would conform to the at least one of delegation and separation of duty (SoD) policies if the user carried out the task.

12. A computer program as claimed in claim 9, comprising computer readable instructions for checking whether the user conforms to attributes associated with the task, and registering the task only if the user conforms to the attributes.
